(19) United States
(12) Patent Application Publication
(10) Pub. No.: US 2024/0095732 A1
(43) Pub. Date: Mar. 21, 2024

(54) INFORMATION PROCESSING APPARATUS AND NOTIFICATION SYSTEM

(71) Applicant: TOSHIBA TEC KABUSHIKI KAISHA, Tokyo (JP)

(72) Inventors: Nobuo Murofushi, Susono Shizuoka (JP); Shigeaki Suzuki, Gotemba Shizuoka (JP); Wataru Sakurai, Izu Shizuoka (JP); Masaki Kimura, Izunokuni Shizuoka (JP); Yuichiro Kawabe, Mishima Shizuoka (JP); Yuki Suzuki, Izunokuni Shizuoka (JP); Haruka Otake, Mishima Shizuoka (JP)

(21) Appl. No.: 18/318,749

(22) Filed: May 17, 2023

(30) Foreign Application Priority Data
Sep. 21, 2022 (JP) 2022-149716

(51) Int. Cl. G06Q 20/38; G06Q 20/04; G06Q 20/20

(52) U.S. Cl. CPC G06Q 20/389; G06Q 20/047; G06Q 20/209

(57) ABSTRACT

An information processing apparatus includes an acquisition unit that acquires transaction information in which consumer identification information for identifying a consumer is associated with individual item identification information indicating an individual item of a commodity purchased by the consumer in a transaction; a management unit that manages, for an individual consumer, the transaction information acquired by the acquisition unit; a receipt information output unit that outputs, based on the transaction information managed by the management unit, receipt information presented as a receipt to the consumer; a reception unit that receives event information indicating contents of an event targeting a commodity; and a specifying unit that specifies the consumer identification information, corresponding to the individual item identification information of an individual item which is a target of the event information received by the reception unit, with reference to the transaction information managed by the management unit.

### CROSS-REFERENCE TO RELATED APPLICATION

This application is based upon and claims the benefit of priority from Japanese Patent Application No. 2022-149716, filed on Sep. 21, 2022, the entire contents of which are incorporated herein by reference.

### FIELD

Embodiments described herein relate generally to an information processing apparatus and a notification system.

### BACKGROUND

In recent years, commodity logistics management is performed using a radio frequency identification (RFID) technique or the like. A management system used for logistics management manages a process from a manufacturer that manufactures a commodity to a sales store that sells the commodity. For example, a logistics operator or a sales operator reads tag information from an RF tag attached to an individual commodity at the time of arrival and transmits the tag information to a management server. Accordingly, the management server can know which operator manages the individual commodity at the present time.

There is also proposed a system for managing an individual commodity purchased by a consumer. This system manages a sold commodity in association with a consumer who purchases the commodity. When a failure is found in the commodity and the commodity is recalled by a manufacturer (hereinafter, also referred to as “recall”), the system specifies a consumer who purchases the recalled commodity. Then, the system notifies the specified consumer of recall information. In this manner, when an event related to a commodity such as a recall occurs, the system can specify a consumer who purchases the commodity, and thus can easily notify the consumer of information about the event.

However, in the system described above, it is necessary to newly provide a consumer database that stores an individual commodity in association with a customer who purchases the commodity. It is also necessary to perform assembly for registering information in the consumer database. Therefore, it is desired to easily implement a system capable of notifying a consumer who purchases a commodity of an event that occurs in the commodity.

### DESCRIPTION OF THE DRAWINGS

FIG. 1 is a diagram illustrating an outline of an entire commodity management system including a logistics management system and a notification system according to an embodiment;

FIG. 2 is a diagram illustrating a data configuration of a company master stored in a logistics management server;

FIG. 3 is a diagram illustrating a data configuration of a logistics management file;

FIG. 4 is a block diagram illustrating a main hardware configuration of an electronic receipt server;

FIG. 5 is a diagram illustrating a data configuration of a member master stored in a storage unit;

FIG. 6 is a diagram illustrating a data configuration of a company master;

FIG. 7 is a diagram illustrating a data configuration of a transaction information management file;

FIG. 8 is a block diagram illustrating a main functional configuration of a control unit;

FIG. 9 is a sequence chart illustrating an operation flow of the commodity management system;

FIG. 10 is a flowchart illustrating a flow of notification destination extracting processing executed by the control unit;

FIG. 11 is a sequence chart illustrating an operation flow of a commodity management system according to a modification; and

FIG. 12 is a flowchart illustrating a flow of event information transmission processing executed by a control unit of an electronic receipt server according to the modification.

### DETAILED DESCRIPTION

In general, according to one embodiment, an information processing apparatus and a notification system capable of easily implementing a system that can notify a consumer who purchases a commodity of an event that occurs in the commodity are provided.

An information processing apparatus according to an embodiment includes an acquisition unit configured to acquire transaction information indicating contents of a transaction, the transaction information being information in which consumer identification information for identifying a consumer is associated with individual item identification information indicating an individual item of a commodity purchased by the consumer in the transaction; a management unit configured to manage, for an individual consumer, the transaction information acquired by the acquisition unit; a receipt information output unit configured to output, based on the transaction information managed by the management unit, receipt information presented as a receipt to the consumer; a reception unit configured to receive event information indicating contents of an event targeting a commodity; and a specifying unit configured to specify the consumer identification information, corresponding to the individual item identification information of an individual item which is a target of the event information received by the reception unit, with reference to the transaction information managed by the management unit.

Hereinafter, an information processing apparatus and a notification system according to an embodiment will be described with reference to the drawings. The present disclosure is not limited to embodiments to be described below. For example, in an embodiment to be described below, an example will be described in which the information processing apparatus is applied to an electronic receipt server that manages receipt information of a plurality of stores, but the present disclosure is not limited thereto. The information processing apparatus may be an electronic receipt server that manages receipt information of one store.

In the following description, an event refers to a matter indicating that a manufacturer, a logistics operator, a sales store, or the like notifies a consumer who purchases a commodity. Examples of the event include various matters such as a recall, version up of software, expiration of a best-before date, and expiration of a warranty period. The event can be freely determined by a manufacturer, a logistics operator, a sales store, or the like.

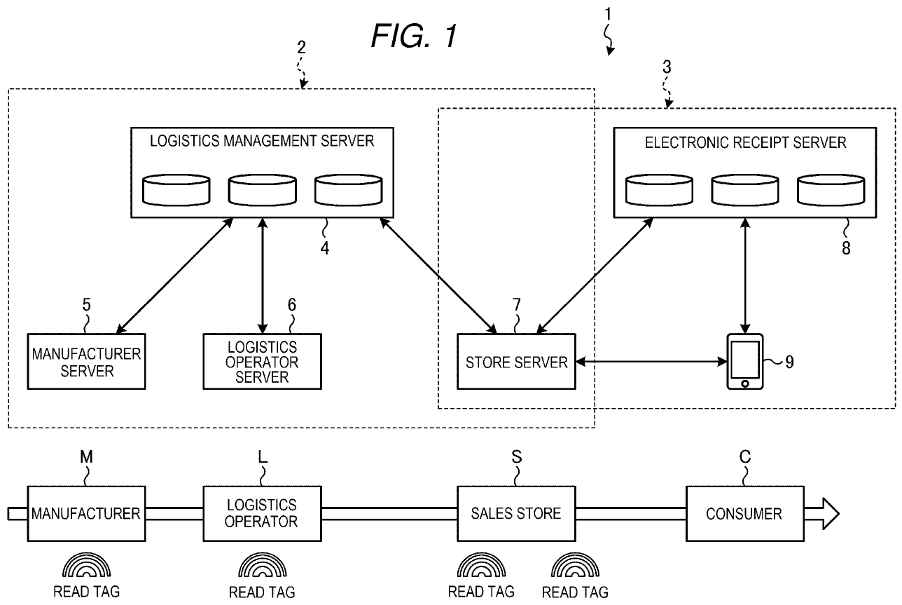

FIG. 1 is a diagram illustrating an outline of a commodity management system 1. The commodity management system 1 includes a logistics management system 2 and a notification system 3. The logistics management system 2 is constructed across a plurality of manufacturers M, a plurality of logistics operators L, and a plurality of sales stores S. The notification system 3 is constructed across a plurality of sales stores S and a plurality of consumers C. The notification system 3 is a system that provides an electronic receipt to the consumer C, and can also be referred to as an electronic receipt system.

The logistics management system 2 includes a logistics management server 4, a manufacturer server 5, a logistics operator server 6, and a store server 7. The logistics management server 4, the manufacturer server 5, the logistics operator server 6, and the store server 7 are communicably connected to one another via a network such as the Internet.

The logistics management server 4 manages a distribution process up to an individual commodity (an individual item) manufactured by the manufacturer M arrives at the sales store S. Here, a commodity refers to a commodity in a range specified by Japanese article number (JAN) code or the like, and an individual item refers to an individual article belonging to the commodity. That is, one commodity includes many individual items.

For example, the logistics management server 4 acquires individual item information including tag information read from an RF tag attached to an individual item by the manufacturer M when the individual item is shipped. The tag information includes a serial code for identifying an individual item. The serial code is an example of individual item identification information. The logistics management server 4 acquires, from the manufacturer server 5, individual item information including a company code of the manufacturer M, a serial code, a commodity code, date information indicating a shipping date, and the like.

Similarly, the logistics management server 4 acquires the individual item information including the tag information read from an RF tag attached to an individual item by a logistics operator L when the individual item arrives. The individual item information includes a company code of a logistics operator L, a serial code, a commodity code, date information indicating a shipping date, and the like.

The logistics management server 4 acquires the individual item information including the tag information read from an RF tag attached to an individual item by a sales store S when the individual item arrives. The individual item information includes a company code of a company that operates the sales store S, a store code of the sales store S, a serial code, a commodity code, date information indicating a shipping date, and the like. The logistics management server 4 can manage a distribution process of an individual item shipped from the manufacturer M by managing the individual item information acquired from an individual company.

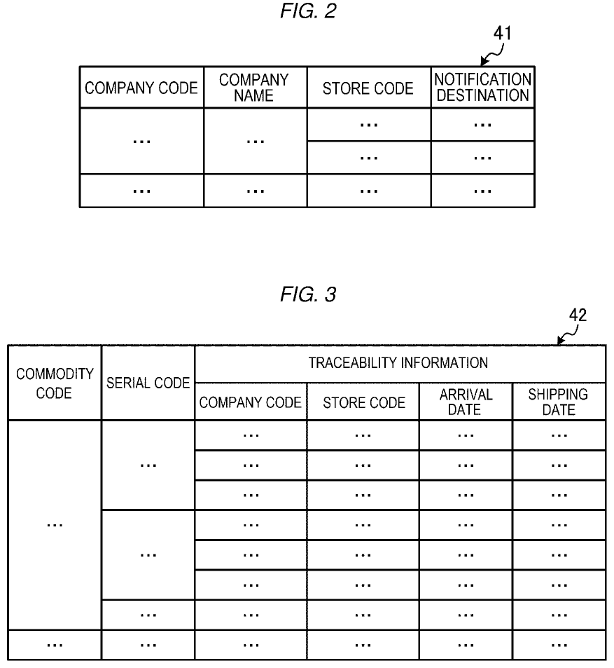

Here, information stored in a storage unit of the logistics management server 4 will be described with reference to FIGS. 2 and 3. The logistics management server 4 stores a company master 41 and a logistics management file 42.

The company master 41 is a master file that stores information about a company that uses the logistics management system 2. The information stored in the company master 41 is acquired from an individual company when the company requests the use of the logistics management system 2. FIG. 2 is a diagram illustrating a data configuration of the company master 41. The company master 41 stores a company name, a store code, and a notification destination in association with a company code.

The company code is a code for identifying a company that is the manufacturer M, a company that is the logistics operator L, and a company that operates the sales store S. The company name is information indicating a name of a company. The store code is a code for identifying the sales store S. When one company operates a plurality of sales stores S, a plurality of store codes are stored in association with the company code and the company name. When the company is the manufacturer M or the logistics operator L, information is not registered in the store code in principle. Information indicating a notification destination of a company or a store is registered as the notification destination. The notification destination is, for example, a communication address of the manufacturer server 5, the logistics operator server 6, the store server 7, or the like.

The logistics management file 42 is a file for managing a commodity distribution process for an individual item. The logistics management file 42 is updated based on the individual item information received by the logistics management server 4 from the manufacturer server 5, the logistics operator server 6, and the store server 7. FIG. 3 is a diagram illustrating a data configuration of the logistics management file 42. The logistics management file 42 stores a commodity code, a serial code, and traceability information in association with one another.

The commodity code is a code for identifying a commodity, and is, for example, a JAN code. The serial code is a code for identifying an individual item. The traceability information includes a company code, a store code, an arrival date, and a shipping date. The company code is a company code for identifying a company that manages an individual item identified by the serial code. The company code includes company codes of a plurality of companies related to a distribution process of an individual item. The store code is an example of sales store identification information for identifying the sales store S. The arrival date is information indicating a date when an individual item arrives at a company identified by the company code. The shipping date is information indicating a date when a company identified by the company code ships an individual item. The logistics management file 42 may not store the shipping date.

The manufacturer server 5 is managed by the manufacturer M and manages information about an individual item manufactured by the manufacturer M. The manufacturer M uses an RFID reading device (not shown) to read the tag information of an RF tag attached to an individual item when the individual item is shipped. The manufacturer server 5 transmits, to the logistics management server 4, individual item information in which a company code of the manufacturer M, date information indicating a shipping date, and the like are associated with a serial code and a commodity code included in the tag information acquired from the RFID reading device.

The logistics operator server 6 is managed by the logistics operator L and manages information about an individual item received from the manufacturer M. The logistics operator L uses an RFID reading device (not shown) to read the tag information of an RF tag attached to the individual item when the individual item is received from the manufacturer M. The logistics operator server 6 transmits, to the logistics management server 4, individual item information in which a company code of the logistics operator L, date information indicating a shipping date, and the like are associated with a serial code and a commodity code included in the tag information acquired from the RFID reading device.

The store server 7 is managed by the sales store S that sells a commodity, and manages various information about the sales store S. For example, the store server 7 manages information about an individual item received from the logistics operator L and sold by the sales store S. The sales store S uses an RFID reading device (not shown) to read the tag information of an RF tag attached to an individual item when the individual item is received from the logistics operator L. The store server 7 transmits, to the logistics management server 4, individual item information in which a store code, a company code of a company that operates the sales store S, date information indicating a sales date, and the like are associated with a serial code and a commodity code included in the tag information acquired from the RFID reading device.

The store server 7 manages various kinds of information about an individual item purchased by the consumer C and transaction information related to a transaction of the individual item. When the consumer C purchases an individual item, the sales store S uses an RFID reading device (not shown) to read the tag information of an RF tag attached to the individual item. The read tag information is input to a point of sales (POS) terminal (not shown) in the sales store S. The POS terminal executes checkout processing based on the received tag information, and transmits transaction information of one transaction to the store server 7. The store server 7 performs sales management at the sales store S based on the received transaction information. The sales store S may be a sales store S that displays individual items of various commodities on a sales floor, or may be a sales store S that sells commodities via the Internet.

The notification system 3 includes the store server 7, an electronic receipt server 8, and a consumer terminal 9. The store server 7, the electronic receipt server 8, and the consumer terminal 9 are communicably connected to one another via a network such as the Internet.

The electronic receipt server 8 receives transaction information from the store server 7 and manages the transaction information. The electronic receipt server 8 also manages information about a member who receives an electronic receipt service, in other words, a consumer. Based on the managed transaction information, the electronic receipt server 8 generates receipt information which is information for displaying an electronic receipt on the consumer terminal 9. Then, the electronic receipt server 8 discloses the receipt information on a web page, and appropriately transmits the receipt information to the consumer terminal 9 in response to a request from the consumer terminal 9. Here, a data format of the receipt information transmitted by the electronic receipt server 8 is not limited. The consumer C can view the receipt information received from the electronic receipt server 8 by using the consumer terminal 9.

The electronic receipt server 8 receives a notification destination request including event information from the store server 7. The notification destination request is a request for specifying a notification destination of the event information included in the notification destination request. The event information is information indicating contents of an event related to a commodity. The event related to a commodity includes a recall, expiration of a best-before date of food or the like, version up of an electric appliance or the like, expiration of a warranty period, and the like. The event is not limited to those described above, and can be widely applied to those having contents to be notified to the consumer C.

The store server 7 transmits a notification destination request to the electronic receipt server 8 based on event information acquired from the manufacturer M or the logistics operator L, event information input at the sales store S, or the like. For example, when a commodity needs to be recalled, the store server 7 acquires recall information output from the manufacturer server 5 and outputs the notification destination request. The electronic receipt server 8 receives, from the store server 7, the request for specifying a notification destination of the consumer C who is a sales destination of an individual item to be recalled.

The notification destination request includes information necessary for specifying the consumer C (hereinafter also referred to as “specifying necessary information”). For example, when an event is a recall, the specifying necessary information is a serial code of an individual item to be recalled. The electronic receipt server 8 refers to the managed transaction information and specifies the consumer C who purchases the individual item identified by the serial code included in the notification destination request. Then, the electronic receipt server 8 specifies a notification destination of the specified consumer C with reference to managed information of the consumer C, that is, member information of an electronic receipt service. The electronic receipt server 8 transmits information indicating the specified notification destination (hereinafter, also referred to as “notification destination information”) to the store server 7 that is a transmission source of the notification destination request. The store server 7 transmits the event information to the consumer terminal 9 based on the received notification destination information. The electronic receipt server 8 is an example of an information processing apparatus. The electronic receipt server 8 is also an example of a server device.

When an event is expiration of a warranty period that occurs due to elapse of a predetermined period from a sales date, the specifying necessary information is a sales date or the like. The electronic receipt server 8 specifies the consumer C who purchases an individual item sold on a sales date included in the notification destination request with reference to the managed transaction information. In a similar manner to the above, the electronic receipt server 8 specifies a notification destination of the specified consumer C with reference to the managed information of the consumer C, and transmits the notification destination information to the store server 7.

The notification destination information transmitted by the electronic receipt server 8 preferably includes a member code for identifying the consumer C and a mail address of the consumer C, and may include at least one of the member code and the mail address. For example, when the store server 7 manages customer information in which a member code and a mail address are associated with each other, the electronic receipt server 8 may transmit notification destination information including only the member code. In this case, the store server 7 specifies a mail address corresponding to the received member code based on the customer information managed by the store server 7, and transmits the event information, a serial code of an individual item that is a target of the event, and the like to the consumer terminal 9 using the specified mail address as a destination.

When the electronic receipt server 8 can communicate with the manufacturer server 5 or the logistics operator server 6, the electronic receipt server 8 may receive a notification destination request from the manufacturer server 5 or the logistics operator server 6. In this case, the electronic receipt server 8 specifies a notification destination based on the specifying necessary information included in the notification destination request, and transmits the notification destination information to the store server 7. For example, the electronic receipt server 8 refers to the managed transaction information, and when the specifying necessary information is a serial code, the electronic receipt server 8 identifies the sales store S that sells an individual item identified by the serial code. Then, the electronic receipt server 8 transmits the notification destination information to the store server 7 of the specified sales store S.

In addition, the electronic receipt server 8 may transmit the notification destination information to the manufacturer server 5 or the logistics operator server 6 which is a transmission source of the notification destination request. In this case, the manufacturer server 5 or the logistics operator server 6 that received the notification destination information transmits the event information to the consumer terminal 9 based on the notification destination information.

The consumer terminal 9 is a terminal device such as a smartphone owned by the consumer C who is a member of the electronic receipt service. The consumer terminal 9 transmits a receipt information request to the electronic receipt server 8 and receives receipt information from the electronic receipt server 8 as a response to the request. The consumer terminal 9 displays an electronic receipt based on the received receipt information.

The consumer terminal 9 receives the event information from the store server 7 and displays the event information. Accordingly, the consumer C can recognize that an event occurs in an individual item purchased by the consumer C. For example, when the event is a recall, the consumer C can recognize that a corresponding individual item needs to be returned to the sales store S. In addition, when an event is expiration of a warranty period, the consumer C can recognize that a corresponding individual item is no longer covered by a warranty.

As described above, when an event related to a commodity occurs, the notification system 3 can notify the consumer C of the event, the consumer C being a consumer who purchases an individual item which is a target of the event. In addition, the notification system 3 can be easily constructed by using the electronic receipt server 8 for providing an electronic receipt to the consumer C. As illustrated in a modification to be described later, the consumer terminal 9 may receive the event information from the electronic receipt server 8.

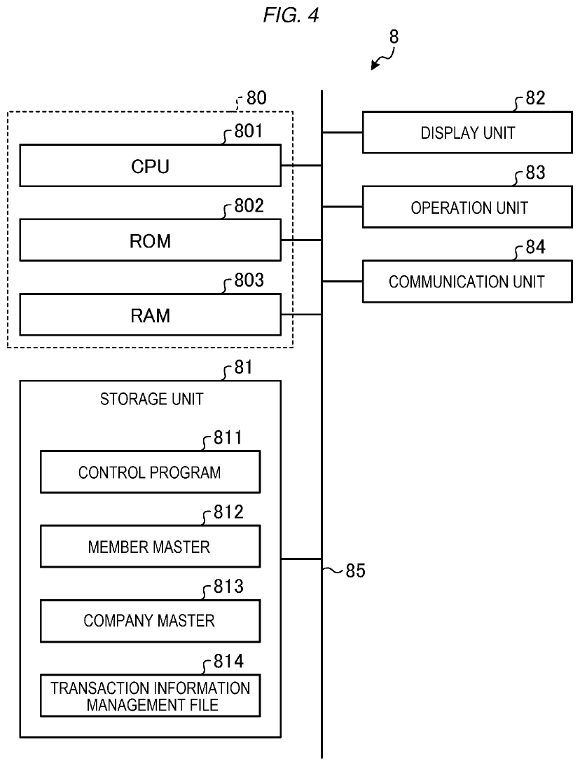

Next, the electronic receipt server 8 will be described in detail. FIG. 4 is a block diagram illustrating a main hardware configuration of the electronic receipt server 8. The electronic receipt server 8 includes a control unit 80, a storage unit 81, a display unit 82, an operation unit 83, and a communication unit 84. The control unit 80, the storage unit 81, the display unit 82, the operation unit 83, and the communication unit 84 are connected to one another via a bus 85 or the like.

The control unit 80 is implemented by a computer including a central processing unit (CPU) 801, a read only memory (ROM) 802, and a random access memory (RAM) 803. The CPU 801, the ROM 802, and the RAM 803 are connected to one another via the bus 85.

The CPU 801 controls an entire operation of the electronic receipt server 8. The ROM 802 stores various programs such as a program used for driving the CPU 801 and various kinds of data. The RAM 803 is used as a work area of the CPU 801, and various programs and various kinds of data stored in the ROM 802 or the storage unit 81 are loaded into the RAM 803. The control unit 80 executes various kinds of control processing of the electronic receipt server 8 when the CPU 801 is operated according to a control program stored in the ROM 802 or the storage unit 81 and loaded into the RAM 803.

The storage unit 81 includes a storage medium such as a hard disk drive (HDD) or a flash memory, and maintains stored contents even when power is turned off. The storage unit 81 stores a control program 811, a member master 812, a company master 813, and a transaction information management file 814.

The control program 811 is a program for implementing a function of acquiring the transaction information from the store server 7 of the individual sales store S and managing the transaction information, a function of generating the receipt information based on the managed transaction information and transmitting the receipt information to the consumer terminal 9, a function of receiving the notification destination request including the event information from the store server 7, a function of specifying the notification destination of the event information included in the received notification destination request, a function of outputting the event information based on the specified notification destination, and the like.

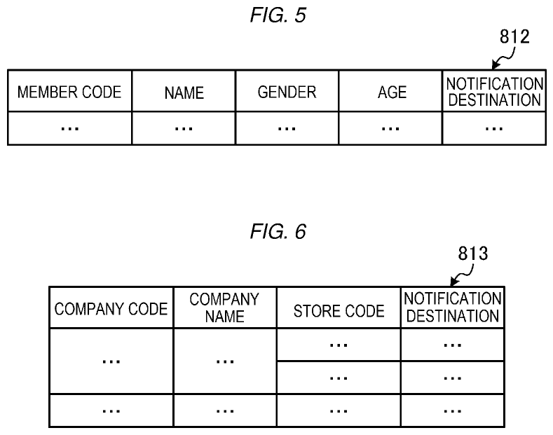

The member master 812 is a master file that stores information about a member of the electronic receipt service, that is, information about the consumer C. Information registered in the member master 812 is acquired from the consumer C when the consumer C performs member registration of the electronic receipt service. FIG. 5 is a diagram illustrating a data configuration of the member master 812. The member master 812 stores name, gender, age, and notification destination in association with a member code.

The member code is a code for specifying a member of the electronic receipt service. The name is information indicating a name of a member. The gender is information indicating gender of a member. The age is information indicating age of a member. The notification destination is, for example, a mail address of the consumer terminal 9 owned by a member. Information about the member code or the notification destination is information for identifying the consumer C and is an example of consumer identification information.

The company master 813 is a master file that stores information about a company participating in the electronic receipt service. Information stored in the company master 813 is acquired from an individual company when the company applies for participation in the electronic receipt service. FIG. 6 is a diagram illustrating a data configuration of the company master 813. The company master 813 stores a company name, a store code, and a notification destination in association with a company code.

The company code is a code for identifying a company that operates the sales store S. The company name is information indicating a name of the company. The store code is a code for identifying the sales store S. When one company operates a plurality of sales stores S, a plurality of store codes are stored in association with the company code and the company name. Information indicating a notification destination of a company or a store is registered as the notification destination. The notification destination is, for example, a communication address of the store server 7.

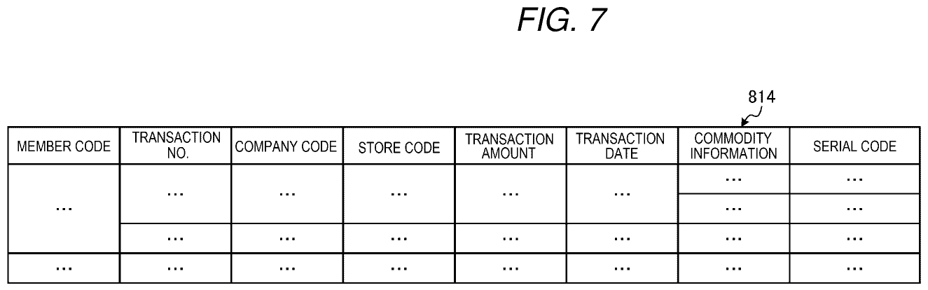

The transaction information management file 814 is a file for managing, for an individual member and for an individual transaction, the transaction information acquired from the store server 7 of the individual sales store S. The transaction information management file 814 is updated based on the transaction information acquired from the store server 7. FIG. 7 is a diagram illustrating a data configuration of the transaction information management file 814. The transaction information management file 814 stores a transaction number, a company code, a store code, a transaction amount, a transaction date, commodity information, and a serial code in association with a member code.

As described above, the member code is a code for specifying a member of the electronic receipt service. The transaction number is information for identifying one transaction at the sales store S. The company code is a code for identifying a company that operates the sales store S in which a transaction is performed. The store code is a code for identifying the sales store S in which a transaction is performed.

The transaction amount is information indicating a transaction amount of one transaction, that is, a total amount of money of commodities purchased in one transaction. The transaction date is information (sales date information) indicating a date when a transaction is performed, that is, a date when an individual item is purchased. The company code, the store code, the transaction amount, and the transaction date are stored in a one-to-one correspondence with the transaction number.

The commodity information is information related to a purchased commodity. The commodity information is, for example, information indicating a commodity code for identifying a commodity, a name, a unit price, and a tax amount of the commodity. The serial code is a code for identifying an individual item of a purchased commodity. When a plurality of individual items are purchased in one transaction, a plurality of pieces of commodity information and serial codes are registered corresponding to the transaction number. The commodity information is stored in a one-to-one correspondence with the serial code.

Referring back to FIG. 4, the hardware configuration of the electronic receipt server 8 will be described.

The display unit 82 may be implemented by, for example, a liquid crystal panel, and displays various kinds of information. The display unit 82 displays, for example, information stored in the member master 812, the company master 813, and the transaction information management file 814 as necessary.

The operation unit 83 inputs information to the control unit 80, and includes a keyboard, a touch panel, and a mouse.

The communication unit 84 is an interface for communicating with an external device such as the store server 7 and the consumer terminal 9. The control unit 80 can transmit information (data) to and receive information (data) from an external device by being connected to the external device via the communication unit 84.

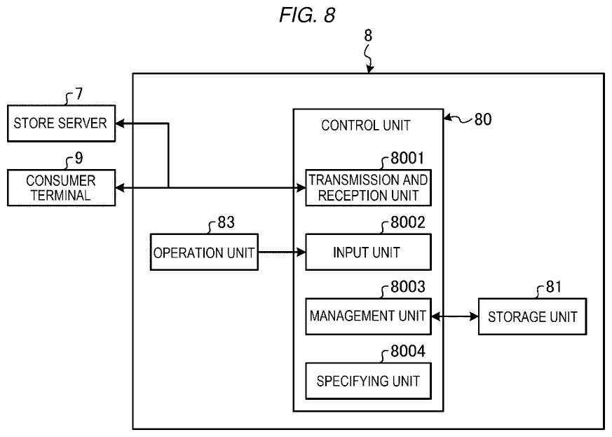

Next, a main functional configuration of the control unit 80 of the electronic receipt server 8 will be described. FIG. 8 is a block diagram illustrating a main functional configuration of the control unit 80 of the electronic receipt server 8. The control unit 80 functions as a transmission and reception unit 8001, an input unit 8002, a management unit 8003, and a specifying unit 8004 when the CPU 801 operates according to a control program stored in the ROM 802 or the storage unit 81. These functions may be implemented by hardware such as a dedicated circuit.

The transmission and reception unit 8001 transmits various kinds of information to and receives various kinds of information from the store server 7 and the consumer terminal 9. For example, the transmission and reception unit 8001 receives transaction information from the store server 7. The transaction information is information in which a member code is associated with a serial code of a commodity purchased by the consumer C in a transaction. The transmission and reception unit 8001 functions as an acquisition unit that acquires the transaction information.

The transmission and reception unit 8001 receives the receipt information request from the consumer terminal 9 and transmits the receipt information to the consumer terminal 9 as a response to the receipt information request. The transmission and reception unit 8001 functions as a receipt information output unit.

The transmission and reception unit 8001 receives the notification destination request from the store server 7. The notification destination request includes the event information indicating that an event occurs in relation to a commodity. The transmission and reception unit 8001 functions as a reception unit that receives the event information.

As a response to the notification destination request, the transmission and reception unit 8001 transmits the notification destination information in which the event information and the consumer identification information are associated with each other to the store server 7 that is a transmission source of the notification destination request. The transmission and reception unit 8001 functions as a first output unit that outputs the event information and the consumer identification information to the sales store S.

Various kinds of information are input to the input unit 8002 from the operation unit 83. For example, when the member master 812, the company master 813, and the transaction information management file 814 are manually updated, information for updating is input to the input unit 8002.

The management unit 8003 manages information stored in the storage unit 81. Here, managing information refers to storing information in the storage unit 81 or reading information from the storage unit 81 as necessary. The management unit 8003 manages the transaction information received by the transmission and reception unit 8001 for the individual consumer C. Specifically, the management unit 8003 registers information in the transaction information management file 814 based on the transaction information received by the transmission and reception unit 8001.

When the transmission and reception unit 8001 receives the receipt information request from the consumer terminal 9, the management unit 8003 reads the transaction information matching the receipt information request from the transaction information management file 814. For example, the management unit 8003 reads the transaction information matching a member code and a transaction date that are specified by the receipt information request, and generates the receipt information.

The specifying unit 8004 refers to the transaction information managed by the management unit 8003, and specifies the consumer identification information corresponding to a serial code of an individual item which is a target of the event information received by the transmission and reception unit 8001. Specifically, when the transmission and reception unit 8001 receives the notification destination request including the event information from the store server 7, the specifying unit 8004 reads a notification destination matching the notification destination request from the member master 812 or the transaction information management file 814. For example, the specifying unit 8004 specifies a member code corresponding to a serial code included in the notification destination request as the consumer identification information in the transaction information management file 814. The specifying unit 8004 may specify a notification destination corresponding to the specified member code as the consumer identification information with reference to the member master 812.

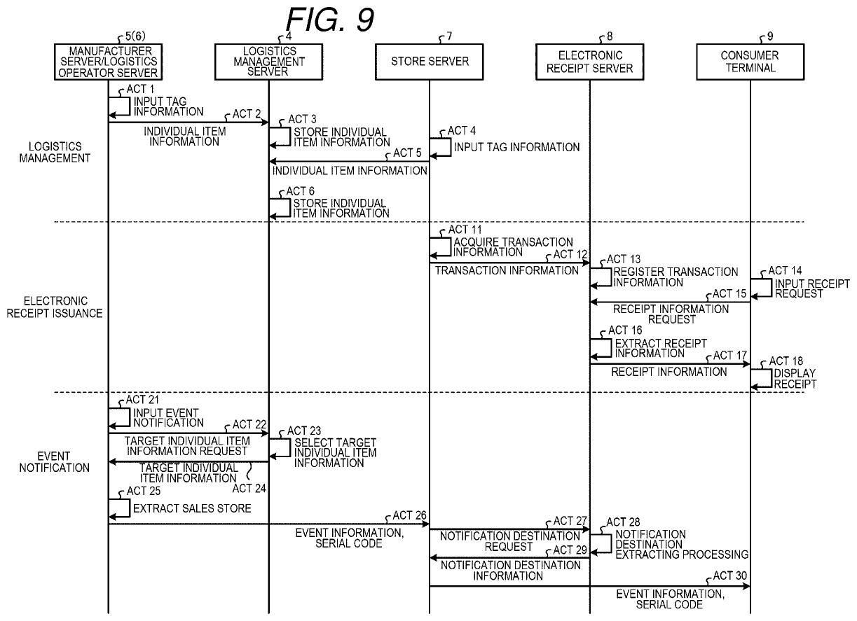

An outline of an operation of the commodity management system 1 having the above-described configuration will be described. FIG. 9 is a sequence chart illustrating an operation flow of the commodity management system 1. Since an operation of the logistics operator server 6 is similar to an operation of the manufacturer server 5, the operation of the manufacturer server 5 will be described, and description of the operation of the logistics operator server 6 will be omitted.

First, an operation of the commodity management system 1 in a distribution process up to an individual item shipped from the manufacturer M arrives at the sales store S will be described. When shipping an individual item, the manufacturer M reads the tag information from an RF tag attached to the individual item. The tag information includes a commodity code of a commodity to which the individual item belongs, a serial code of the individual item, and the like. The tag information may include a company code of the manufacturer M. The tag information is input to the manufacturer server 5 (ACT 1).

The manufacturer server 5 generates the individual item information in which the company code of the manufacturer M and date information indicating a shipping date are associated with the commodity code and the serial code included in the tag information, and transmits the individual item information to the logistics management server 4 (ACT 2).

The logistics management server 4 registers the received individual item information in the logistics management file 42 (ACT 3). When serial code information included in the received individual item information is already registered in the logistics management file 42, the logistics management server 4 adds the company code and the date information included in the received individual item information in association with the serial code. For example, the serial code information included in the individual item information received from the logistics operator server 6 is already registered in the individual item information from the manufacturer server 5. In this case, the logistics management server 4 stores a company code of the logistics operator L and date information that are included in the individual item information received from the logistics operator server 6 in association with the registered serial code.

When the individual item arrives at the sales store S, the sales store S reads the tag information from an RF tag attached to the individual item. The tag information is input to the store server 7 (ACT 4). The store server 7 generates the individual item information in which a store code of the sales store S, a company code of a company that operates the sales store S, and date information indicating an arrival date are associated with a commodity code and a serial code included in the tag information, and transmits the individual item information to the logistics management server 4 (ACT 5). The logistics management server 4 stores the store code, the company code, and the date information included in the individual item information received from the store server 7 in association with the registered serial code (ACT 6).

Through the above operation, the logistics management server 4 can manage a status of the individual item in the distribution process.

Next, an operation of the commodity management system 1 from when an individual item is sold in the sales store S to when an electronic receipt is issued to the consumer C will be described. When an individual item is purchased by the consumer C at the sales store S, checkout processing is executed by a POS terminal (not shown) in the sales store S. The store server 7 acquires the transaction information from the POS terminal (ACT 11). The store server 7 transmits the acquired transaction information to the electronic receipt server 8 (ACT 12).

The electronic receipt server 8 registers the received transaction information in the transaction information management file 814 (ACT 13). When the consumer C who purchases the individual item views an electronic receipt, the receipt information request is input to the consumer terminal 9 (ACT 14). In the receipt information request, a receipt information extraction condition such as a transaction date is input. The consumer terminal 9 transmits the receipt information request including the receipt information extraction condition to the electronic receipt server 8 (ACT 15).

The electronic receipt server 8 searches the transaction information management file 814 based on the receipt information extraction condition included in the received receipt information request, and extracts the receipt information necessary for displaying an electronic receipt (ACT 16). More specifically, the electronic receipt server 8 selects the transaction information matching the receipt information extraction condition from the transaction information management file 814. Then, the electronic receipt server 8 extracts the receipt information necessary for displaying the electronic receipt from the selected transaction information. The electronic receipt server 8 transmits the extracted receipt information to the consumer terminal 9 (ACT 17).

The consumer terminal 9 displays the received receipt information (ACT 18). The consumer terminal 9 displays the receipt information received from the electronic receipt server 8 in a form of a receipt according to an installed electronic receipt application program. The consumer C can view the electronic receipt with the same feeling as a paper receipt.

Next, an operation of the commodity management system 1 when an event related to a commodity occurs and the consumer C who purchases an individual item corresponding to the event is notified of the event information will be described. For example, when an event of which the consumer C who purchases a commodity is to be notified, such as a recall or software version up, occurs, an event notification is input to the manufacturer server 5 (ACT 21). When inputting the event notification, information for selecting an individual item which is a target of the event (hereinafter, also referred to as “selection information”) is input. The selection information is, for example, a serial code of a target individual item, a combination of a commodity code of a target individual item and a shipping date, or the like. The manufacturer server 5 transmits a target individual item information request to the logistics management server 4 (ACT 22). The target individual item information request includes the selection information.

The logistics management server 4 selects target individual item information based on the selection information included in the received target individual item information request (ACT 23). More specifically, the logistics management server 4 refers to the logistics management file 42 and selects a serial code matching the selection information and a store code corresponding to the serial code as the target individual item information. The logistics management server 4 transmits the selected target individual item information to the manufacturer server 5 (ACT 24).

The manufacturer server 5 extracts the sales store S from the received target individual item information (ACT 25). In other words, the manufacturer server 5 extracts, from the target individual item information, the sales store S that sold an individual item that is a target of the event. The manufacturer server 5 transmits information including the event information and a serial code of the individual item that is a target of the event to the store server 7 of the extracted sales store S (ACT 26).

When the manufacturer M knows the sales store S that receives the individual item which is a target of the event, the processing of ACT 22 to ACT 25 is unnecessary. When the manufacturer server 5 can communicate with the electronic receipt server 8, the event information and the serial code may be transmitted to the electronic receipt server 8 in ACT 26.

When the event information and the serial code are received, the store server 7 transmits the notification destination request including the received event information and the serial code to the electronic receipt server 8 (ACT 28). The store server 7 transmits the notification destination request including a store code of the sales store S of the store server 7. In response to the notification destination request, the store server 7 inquires the electronic receipt server 8 about a notification destination of the event information.

When the notification destination request is received, the electronic receipt server 8 executes notification destination extracting processing (ACT 28). Details of the notification destination extracting processing executed by the electronic receipt server 8 will be described later. The electronic receipt server 8 transmits the notification destination information such as a member code and a mail address extracted in the notification destination extracting processing to the store server 7 (ACT 29).

The store server 7 transmits the event information and a serial code of an individual item which is a target of the event to the consumer terminal 9 specified by the received notification destination information (ACT 30). At this time, it is desirable that the store server 7 also transmits information indicating a commodity name to the consumer terminal 9. This is to make it easier for the consumer C to recognize the individual item which is a target of the event. The store server 7 may also transmit additional information to the consumer terminal 9. For example, the store server 7 may transmit advertisement information such as special sale information of the sales store S to the consumer terminal 9 as the additional information. The consumer C can recognize an event for an individual item purchased by the consumer C by checking the event information, the commodity name, and the individual item code that are transmitted to the consumer terminal 9.

Through the above operation, the notification system 3 of the commodity management system 1 can notify the consumer C who purchases an individual item of an event that occurs in the individual item. In addition, since the consumer C is notified of the event information by using information from the electronic receipt server 8 for providing the electronic receipt service to the consumer C, the notification system 3 can be easily implemented. In other words, it is not necessary to newly provide a consumer database for managing the transaction information at a plurality of sales stores S.

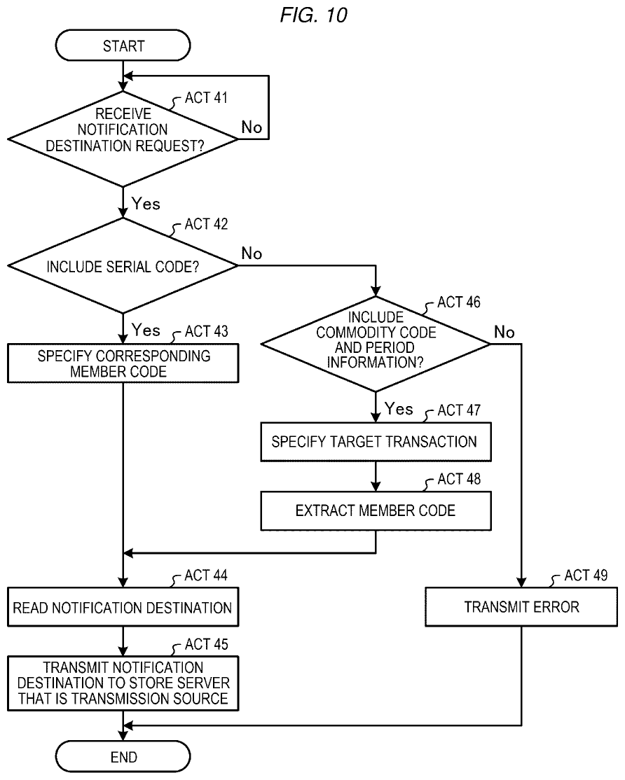

Next, the notification destination extracting processing executed by the electronic receipt server 8 will be described. FIG. 10 is a flowchart illustrating a flow of the notification destination extracting processing executed by the control unit 80 of the electronic receipt server 8.

The control unit 80 determines whether the transmission and reception unit 8001 receives the notification destination request including the event information from the store server 7 (ACT 41). When the transmission and reception unit 8001 does not receive the notification destination request (No in ACT 41), the control unit 80 returns to the processing of ACT 41 and waits.

When the transmission and reception unit 8001 receives the notification destination request from the store server 7 (Yes in ACT 41), the specifying unit 8004 determines whether the notification destination request includes a serial code (ACT 42). When the notification destination request includes a serial code (Yes in ACT 42), the specifying unit 8004 specifies a member code corresponding to the serial code (ACT 43). In other words, the specifying unit 8004 specifies the consumer C who purchases an individual item specified by the serial code included in the notification destination request.

The specifying unit 8004 refers to the member master 812 and reads an address which is a notification destination corresponding to the specified member code (ACT 44). The transmission and reception unit 8001 transmits the read notification destination to the store server 7 that is a transmission source of the notification destination request (ACT 45). Then, the control unit 80 ends the notification destination extracting processing.

The transmission and reception unit 8001 may transmit the member code to the store server 7 as the notification destination. For example, when the store server 7 stores customer data in which the member code and an address of the consumer terminal 9 are associated with each other, the transmission and reception unit 8001 may transmit the member code to the store server 7 as the notification destination.

In the processing of ACT 42, when the notification destination request does not include a serial code (No in ACT 42), the specifying unit 8004 determines whether the notification destination request includes a commodity code and the period information (ACT 46). When the notification destination request includes a commodity code and the period information (Yes in ACT 46), the specifying unit 8004 specifies a target transaction with reference to the transaction information management file 814 (ACT 47). More specifically, the specifying unit 8004 extracts, from the transaction information management file 814, a transaction on a transaction date corresponding to the period information included in the notification destination request. The transaction is a transaction in which a commodity having the commodity code included in the notification destination request is purchased.

The specifying unit 8004 extracts a member code from the transaction information of the specified transaction (ACT 48). In other words, the specifying unit 8004 specifies the consumer C who purchases the commodity in the specified transaction. Then, the control unit 80 proceeds to the processing of ACT 44.

In the processing of ACT 46, when the notification destination request does not include a commodity code or the period information (No in ACT 46), the transmission and reception unit 8001 transmits error information to the store server 7 (ACT 49). That is, the transmission and reception unit 8001 transmits error information indicating that the notification destination request does not include a condition for specifying the notification destination for the store server 7.

According to the above embodiment, it is possible to easily implement a system capable of notifying the consumer C who purchases a commodity of an event that occurs in the commodity. Since the event information is transmitted from the store server 7 to the consumer terminal 9, the store server 7 can also transmit the additional information such as advertisement information of the sales store S together with the event information. Therefore, the sales store S can perform advertising using the notification of an event related to a commodity.

Next, a modification will be described. The modification is different from the above-described example in that the electronic receipt server 8 transmits the event information to the consumer C. In the following description, description of a configuration, a function, and the like that is similar to those of the above-described commodity management system 1 may be omitted.

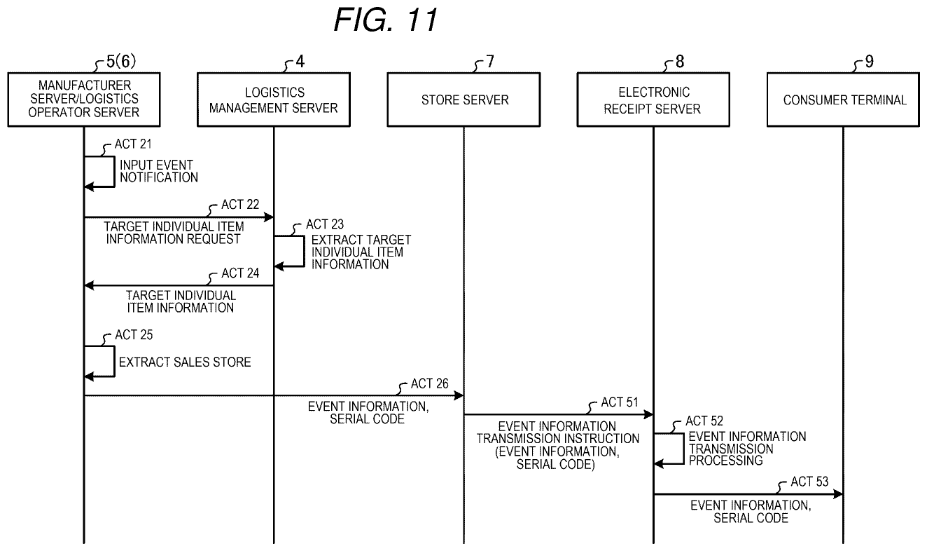

FIG. 11 is a sequence chart illustrating an operation flow of a commodity management system according to the modification. The processing of ACT 21 to ACT 26 is the same as the processing in the above-described example. When the store server 7 receives the event information and a serial code of an individual item which is a target of the event from the manufacturer server 5, the store server 7 transmits an event information transmission instruction to the electronic receipt server 8 (ACT 51). The event information transmission instruction instructs the electronic receipt server 8 to transmit the event information to the consumer terminal 9. The event information transmission instruction includes the event information and the serial code of the individual item which is a target of the event.

When the electronic receipt server 8 receives the event information transmission instruction, the electronic receipt server 8 executes an event information transmission processing (ACT 52). Details of the event information transmission processing will be described later. The electronic receipt server 8 transmits the event information and the serial code of the individual item which is a target of the event to the consumer terminal 9 through the event information transmission processing (ACT 53). At this time, it is desirable that the electronic receipt server 8 also transmits a commodity name to the consumer terminal 9.

Through the above operation, the notification system 3 of the commodity management system 1 can notify the consumer C who purchases an individual item of the event that occurs in the individual item in a similar manner to the above-described example. In addition, the consumer C can be notified of the event information by using the electronic receipt server 8 for providing the electronic receipt service to the consumer C.

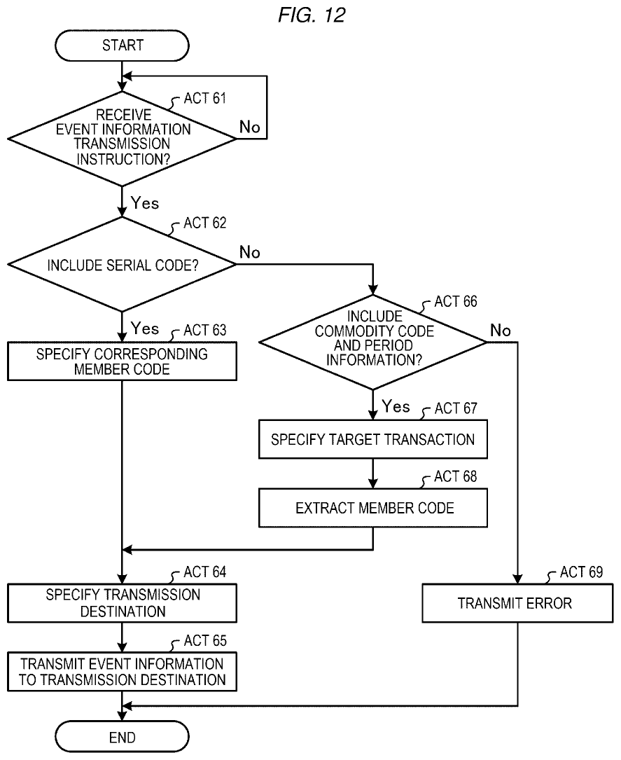

Next, the event information transmission processing executed by the electronic receipt server 8 will be described. FIG. 12 is a flowchart illustrating a flow of the event information transmission processing executed by the control unit 80 of the electronic receipt server 8.

The control unit 80 determines whether the transmission and reception unit 8001 receives the event information transmission instruction from the store server 7 (ACT 61). When the transmission and reception unit 8001 does not receive the event information transmission instruction (No in ACT 61), the control unit 80 returns to the processing of ACT 61 and waits.

When the transmission and reception unit 8001 receives the event information transmission instruction from the store server 7 (Yes in ACT 61), the specifying unit 8004 determines whether the event information transmission instruction includes a serial code (ACT 62). When the event information transmission instruction includes a serial code (Yes in ACT 62), the specifying unit 8004 specifies a member code corresponding to the serial code (ACT 63). In other words, the specifying unit 8004 specifies the consumer C who purchases an individual item specified by the serial code included in the event information transmission instruction.

The specifying unit 8004 reads an address which is a notification destination corresponding to the specified member code with reference to the member master 812, and specifies a transmission destination of the event information (ACT 64). The transmission and reception unit 8001 transmits the event information, the serial code of the individual item that is a target of the event, and information indicating a commodity name to the consumer terminal 9 that is a specified transmission destination (ACT 65). Then, the control unit 80 ends the notification destination extracting processing. The transmission and reception unit 8001 functions as a second output unit that outputs the event information to the consumer C.

In the processing of ACT 62, when the event information transmission instruction does not include a serial code (No in ACT 62), the specifying unit 8004 determines whether the notification destination request includes a commodity code and the period information (ACT 66). When the event information transmission instruction includes a commodity code and the period information (Yes in ACT 66), the specifying unit 8004 specifies a target transaction with reference to the transaction information management file 814 (ACT 67). More specifically, the specifying unit 8004 extracts, from the transaction information management file 814, a transaction on a transaction date corresponding to the period information included in the event information transmission instruction. The transaction is a transaction in which a commodity having the commodity code included in the event information transmission instruction is purchased.

The specifying unit 8004 extracts a member code from the transaction information of the specified transaction (ACT 68). In other words, the specifying unit 8004 specifies the consumer C who purchases a commodity in the specified transaction. Then, the control unit 80 proceeds to the processing of ACT 64.

In the processing of ACT 66, when the event information transmission instruction does not include a commodity code and the period information (No in ACT 66), the transmission and reception unit 8001 transmits the error information to the store server 7 (ACT 69). That is, the transmission and reception unit 8001 transmits the error information indicating that the event information transmission instruction does not include information that is a condition for specifying the transmission destination for the store server 7.

In the modification, it is also possible to easily implement a system capable of notifying a consumer who purchases a commodity of an event that occurs in the commodity. The event information can be transmitted from the electronic receipt server 8 to the consumer terminal 9 using a mechanism for transmitting an electronic receipt to the consumer terminal 9.

As described above, the electronic receipt server 8 according to the embodiment includes an acquisition unit (the transmission and reception unit 8001) that acquires the transaction information indicating contents of a transaction, the transaction information being information in which a member code for identifying a consumer is associated with a serial code indicating an individual item of a commodity purchased by the consumer in the transaction; the management unit 8003 that manages, for an individual consumer, the transaction information acquired by the acquisition unit; a receipt information output unit (the transmission and reception unit 8001) that outputs, based on the transaction information managed by the management unit 8003, receipt information presented as a receipt to the consumer; a reception unit (the transmission and reception unit 8001) that receives the event information indicating contents of an event targeting a commodity; and the specifying unit 8004 that specifies the member code, corresponding to the serial code of an individual item that is a target of the event information received by the reception unit, with reference to the transaction information managed by the management unit 8003.

Accordingly, the electronic receipt server 8 can easily specify a consumer who purchases an individual item which is a target of an event. Therefore, the notification system 3 can notify the consumer who purchases the individual item of an occurred event, the individual item being a target of the event. Since the electronic receipt server 8 for providing an electronic receipt service is used, it is not necessary to newly provide a consumer database or the like, and it is possible to easily construct a system that notifies a consumer of an event.

In the electronic receipt server 8 according to the embodiment, the event information received by the transmission and reception unit 8001 includes the serial code of a commodity that is a target of the event, and the specifying unit 8004 specifies the member code corresponding to the serial code included in the event information with reference to transaction information.

Accordingly, by managing the serial code, the electronic receipt server 8 can specify a consumer who purchases an individual item which is a target of the event, even when the event is an event based on a manufacturing date of the commodity, for example, a recall or expiration of a best-before date.

Further, in the electronic receipt server 8 according to the embodiment, the event information received by the transmission and reception unit 8001 includes the period information for specifying a period from a sales date, the transaction information includes the sales date information associated with the member code, and the specifying unit 8004 selects the transaction information matching the period information included in the event information with reference to the sales date information of the transaction information, and specifies the member code corresponding to the selected transaction information.

Accordingly, the electronic receipt server 8 can specify a consumer who purchases an individual item which is a target of the event by using information indicating a transaction date that was disclosed in the related art. Therefore, in the case of an event based on a sales date of a commodity, such as a notification that a warranty period from a sales date is expired, the electronic receipt server 8 does not need to newly manage a serial code of a commodity of a transaction.

In addition, in the electronic receipt server 8 according to the embodiment, the transmission and reception unit 8001 further includes a first output unit (the transmission and reception unit 8001) that receives a store code for identifying the sales store S and outputs the event information received by the transmission and reception unit 8001 and the member code specified by the specifying unit 8004 to the sales store S specified by the store code.

Accordingly, the sales store S can notify the consumer of an occurred event. Therefore, the sales store S can provide additional information such as an advertisement to a consumer together with the notification of an event.

The electronic receipt server 8 according to the embodiment further includes a second output unit (the transmission and reception unit 8001) that outputs the event information received by the transmission and reception unit 8001 to the consumer identified by the member code specified by the specifying unit 8004.

Accordingly, the sales store S does not need to notify a consumer of an occurred event. Therefore, information managed by the sales store S is reduced, and a load on the sales store S can be reduced.

In the above-described embodiment, control programs executed by the store server 7, the electronic receipt server 8, and the consumer terminal 9 may be provided by being recorded in a computer-readable recording medium such as a CD-ROM. The control programs executed by the above devices may be provided by being stored in a computer connected to a network such as the Internet and being downloaded via the network, or may be provided via a network such as the Internet.

While the embodiment described herein has been explained above, the embodiment has been presented by way of example only, and is not intended to limit the scope of the exemplary embodiment. The embodiment can be implemented in various other forms, and various omissions, substitutions, and changes can be made without departing from the gist of the disclosure.

For example, instead of an RF tag, a two-dimensional code may be used as a medium that stores the individual item identification information. In this case, a commodity may be attached with a label on which a two-dimensional code indicating the individual item identification information is printed, and the manufacturer M, the logistics operator L, and the sales store S may read the individual item identification information from the two-dimensional code attached to the commodity using a two-dimensional code reader.

What is claimed is:

1. An information processing apparatus, comprising:
an acquisition component configured to acquire transaction information indicating contents of a transaction, the transaction information being information in which consumer identification information for identifying a consumer is associated with individual item identification information indicating an individual item of a commodity purchased by the consumer in the transaction;
a management component configured to manage, for an individual consumer, the transaction information acquired by the acquisition component;
a receipt information output component configured to output, based on the transaction information managed by the management component, receipt information presented as a receipt to the consumer;
a reception component configured to receive event information indicating contents of an event targeting a commodity; and
a specifying component configured to specify the consumer identification information, corresponding to the individual item identification information of an individual item which is a target of the event information received by the reception component, with reference to the transaction information managed by the management component.

2. The information processing apparatus according to claim 1, wherein
the event information received by the reception component includes the individual item identification information of the commodity which is a target of the event, and
the specifying component specifies the consumer identification information corresponding to the individual item identification information included in the event information with reference to the transaction information.

3. The information processing apparatus according to claim 1, wherein
the event information received by the reception component includes period information for specifying a time period from a sales date, and the transaction information includes the sales date information associated with the individual identification information, and
the specifying component refers to the sales date information in the transaction information, selects the transaction information matching the time period included in the event information, and specifies the consumer identification information in the selected transaction information.

4. The information processing apparatus according to claim 1, wherein
the reception component receives sales store identification information for identifying a sales store, and
the information processing apparatus further comprises:
a first output component configured to output the event information received by the reception component and the consumer identification information specified by the specifying component to the sales store identified by the sales store identification information.

5. The information processing apparatus according to claim 1, further comprising:
a second output component configured to output the event information received by the reception unit to a consumer identified by the consumer identification information specified by the specifying component.

6. The information processing apparatus according to claim 1, wherein
the event includes at least one of a recall, a version up of software, an expiration of a best-before date, and an expiration of a warranty period.

7. The information processing apparatus according to claim 1, wherein
the acquisition component acquires transaction information from an RF tag.

8. A notification system, comprising:
a store server provided in a sales store that sells a commodity; and
a server device that manages transaction information of a transaction in the sales store, wherein
the server device includes
an acquisition component configured to acquire, from the store server, transaction information indicating contents of a transaction, the transaction information being information in which consumer identification information for identifying a consumer, individual item identification information indicating an individual item of a commodity purchased by the consumer in the transaction, and sales store identification information for identifying a sales store that sells the individual item are associated with one another,
a management component configured to manage, for an individual consumer, the transaction information acquired by the acquisition component,
a receipt information output component configured to output, based on the transaction information managed by the management component, receipt information presented as a receipt to the consumer,
a reception component configured to receive event information indicating contents of an event targeting a commodity,
a specifying component configured to specify the consumer identification information, corresponding to the individual item identification information of an individual item which is a target of the event information received by the reception component, with reference to the transaction information managed by the management component, and
a transmission component configured to transmit the event information received by the reception component and the consumer identification information specified by the specifying unit to the store server of the sales store specified by the sales store identification information, and
the store server includes
a transmission component configured to transmit the event information received from the server device to a consumer terminal of the consumer identified by the consumer identification information received from the server device.

9. The notification system according to claim 8, wherein
the event information received by the reception component includes the individual item identification information of the commodity which is a target of the event, and
the specifying component specifies the consumer identification information corresponding to the individual item identification information included in the event information with reference to the transaction information.

10. The notification system according to claim 8, wherein
the event information received by the reception component includes period information for specifying a time period from a sales date, and the transaction information includes the sales date information associated with the individual identification information, and
the specifying component refers to the sales date information in the transaction information, selects the transaction information matching the time period included in the event information, and specifies the consumer identification information in the selected transaction information.

11. The notification system according to claim 8, wherein
the reception component receives sales store identification information for identifying a sales store, and
the information processing apparatus further comprises:
a first output component configured to output the event information received by the reception component and the consumer identification information specified by the specifying component to the sales store identified by the sales store identification information.

12. The notification system according to claim 8, further comprising:
a second output component configured to output the event information received by the reception unit to a consumer identified by the consumer identification information specified by the specifying component.

13. The notification system according to claim 8, wherein
the event includes at least one of a recall, a version up of software, an expiration of a best-before date, and an expiration of a warranty period.

14. The notification system according to claim 8, wherein
the acquisition component acquires transaction information from an RF tag.

15. A notification system, comprising:
a consumer terminal associated with a consumer; and
a server device configured to manage transaction information of a transaction conducted by the consumer, wherein
the server device includes
an acquisition component configured to acquire transaction information indicating contents of a transaction, the transaction information being information in which consumer identification information for identifying a consumer is associated with individual item identification information indicating an individual item of a commodity purchased by the consumer in the transaction,
a management component configured to manage, for an individual consumer, the transaction information acquired by the acquisition component,
a receipt information output component configured to output, based on the transaction information managed by the management component, receipt information to the consumer terminal, the receipt information being presented as a receipt to the consumer,
a reception component configured to receive event information indicating contents of an event targeting a commodity,
a specifying component configured to specify the consumer identification information, corresponding to the individual item identification information of an individual item which is a target of the event information received by the reception component, with reference to the transaction information managed by the management component, and
a transmission component configured to transmit the event information received by the reception component to the consumer terminal of a consumer identified by the consumer identification information specified by the specifying component.

16. The notification system according to claim 15, wherein
the event information received by the reception component includes the individual item identification information of the commodity which is a target of the event, and
the specifying component specifies the consumer identification information corresponding to the individual item identification information included in the event information with reference to the transaction information.

17. The notification system according to claim 15, wherein
the event information received by the reception component includes period information for specifying a time period from a sales date, and the transaction information includes the sales date information associated with the individual identification information, and
the specifying component refers to the sales date information in the transaction information, selects the transaction information matching the time period included in the event information, and specifies the consumer identification information in the selected transaction information.

18. The notification system according to claim 15, wherein
the reception component receives sales store identification information for identifying a sales store, and
the information processing apparatus further comprises:
a first output component configured to output the event information received by the reception component and the consumer identification information specified by the specifying component to the sales store identified by the sales store identification information.

19. The notification system according to claim 15, further comprising:
a second output component configured to output the event information received by the reception unit to a consumer identified by the consumer identification information specified by the specifying component.

20. The notification system according to claim 15, wherein
the event includes at least one of a recall, a version up of software, an expiration of a best-before date, and an expiration of a warranty period.
